(19) United States
(12) Patent Application Publication
(10) Pub. No.: US 2019/0314992 A1
(43) Pub. Date: Oct. 17, 2019

(54) METHOD OF OPERATING ROBOT, COMPUTER PROGRAM, AND ROBOT SYSTEM

(71) Applicant: KAWASAKI JUKOGYO KABUSHIKI KAISHA, Kobe-shi, Hyogo (JP)

(72) Inventors: Yasuhiko HASHIMOTO, Kobe-shi (JP); Masayuki KAMON, Akashi-shi (JP)

(73) Assignee: KAWASAKI JUKOGYO KABUSHIKI KAISHA, Kobe-shi, Hyogo (JP)

(21) Appl. No.: 16/319,595

(22) PCT Filed: Jul. 20, 2017
(86) PCT No.: PCT/JP2017/026226

§ 371 Date: Jan. 22, 2019

(30) Foreign Application Priority Data
Jul. 22, 2016 (JP) 2016-144973

(51) Int. Cl. B25J 9/16

(52) U.S. Cl. CPC B25J 9/1671; B25J 9/1628

(57) ABSTRACT

A method of operating a robot includes acquiring a first condition that defines a given model work, acquiring for the model work, conversion information for acquiring first corrected operation information based on first temporary operation information of the robot, acquiring a second condition that defines a given target work, and acquiring second corrected operation information indicative of corrected operation of the robot for the target work based on the first condition, the second condition, and the conversion information.

### TECHNICAL FIELD

The present disclosure relates to a method of operating a robot which performs a series of works including a plurality of processes, and also relates to a computer program and a robot system.

### BACKGROUND ART

Conventionally, at manufacturing sites, a repeating work, such as welding, painting, assembling of parts, or applicating of sealing agent, is automatically performed by an industrial robot. In order to cause the robot to perform the work, “teaching” in which teachings, such as operation information required for the work and corrected information which is obtained by modifying and optimizing the operation information is given to and stored in the robot is needed. The method of teaching the robot includes, for example, a direct teaching method in which an operator directly touches and operates the robot, a teaching method in which the operator remotely manipulates the robot by using a teaching pendant, a teaching method by programming, and a teaching method using a master-slave relation. For example, Patent Document 1 discloses one example of a teaching work in which a route of a work is stored in a robot by using the direct teaching.

### REFERENCE DOCUMENT OF CONVENTIONAL ART

### Patent Document

[Patent Document 1] JP2013-71231A

### DESCRIPTION OF THE DISCLOSURE

### Problems to be Solved by the Disclosure

Since the robot handles the various works as described above, teaching is needed for each work as the type of work differs, such as welding and painting. Further, even if the robot handles the same type of works, when the content of the works differ, teaching is still needed according to the content. For example, regarding the application work of sealing agent, if a target part of a product differs, teaching of operation according to the target part must be performed. Moreover, the operation taught once may be made more suitable. However, since these works may require an expert's technique and require time and labors, the operator's burden is not negligible.

Thus, one purpose of the present disclosure is to provide a method of operating a robot, a computer program, and a robot system, which are capable of easily acquiring information on operation of the robot according to a work, and reducing operator's burden.

### SUMMARY OF THE DISCLOSURE

A method of operating a robot according to one aspect of the present disclosure is to perform a series of works including a plurality of processes. The method includes acquiring a first condition that defines a given model work, acquiring for the model work, conversion information for acquiring first corrected operation information indicative of corrected operation obtained by correcting a temporary operation based on first temporary operation information indicative of the temporary operation of the robot that satisfies the first condition, acquiring a second condition that defines a given target work, and acquiring second corrected operation information indicative of corrected operation of the robot for the target work based on the first condition, the second condition, and the conversion information.

Thus, regarding the operation of the robot for the target work, the corrected operation information corresponding to the corrected operation can be acquired without an actual correction. That is, by automatically applying the logic of the correction when the corrected operation for the model work is acquired based on the temporary operation, the corrected operation information for the target work can easily be acquired.

A computer program according to one aspect of the present disclosure causes a computer of a robot system to execute processing, the robot system including a robot configured to execute a series of works including a plurality of processes, the computer configured to control operation of the robot. The processing includes acquiring a first condition that defines a given model work, acquiring for the model work, conversion information for acquiring first corrected operation information indicative of corrected operation obtained by correcting a temporary operation based on first temporary operation information indicative of the temporary operation of the robot that satisfies the first condition, acquiring a second condition that defines a given target work, and acquiring second corrected operation information indicative of corrected operation of the robot for the target work based on the first condition, the second condition, and the conversion information.

A robot system according to one aspect of the present disclosure is to perform a series of works including a plurality of processes. The robot system includes a robot, a memory storing a first condition that defines a given model work, and for the model work, conversion information for acquiring first corrected operation information indicative of corrected operation obtained by correcting a temporary operation based on first temporary operation information indicative of the temporary operation of the robot that satisfies the first condition, and a processor configured to acquire second corrected operation information indicative of corrected operation of the robot for the target work based on the first condition, the conversion information, and a second condition that defines a given target work.

### Effects of the Disclosure

The present disclosure can provide a method of operating the robot, a computer program, and a robot system, which are capable of easily acquiring the information on the operation of the robot according to the work, and reducing the burden of correcting the operation of the robot.

### BRIEF DESCRIPTION OF DRAWINGS

FIG. 1 is a view schematically illustrating one example of a configuration of a robot system according to one embodiment.

FIG. 2 is a block diagram illustrating a functional configuration of a control device.

FIG. 3 is a flowchart illustrating a method of operating a robot.

FIG. 4 is a view schematically illustrating one example of a control of operation of the robot according to a processing A of FIG. 3.

FIG. 5 is a view schematically illustrating one example of a control of operation of the robot according to a processing B of FIG. 3.

### MODES FOR CARRYING OUT THE DISCLOSURE

Hereinafter, a method of operating a robot, a computer program, and a robot system according to embodiments of the present disclosure will be described with reference to the drawings.

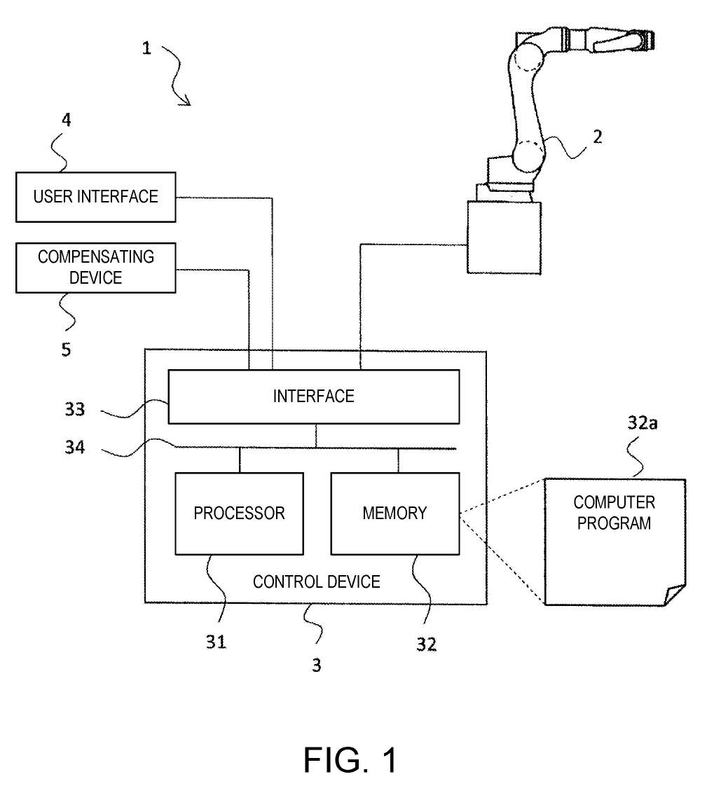

The first embodiment is described first. FIG. 1 is a view schematically illustrating one example of a configuration of the robot system according to this embodiment. As illustrated in FIG. 1, the robot system 1 includes a robot 2, a control device 3, an user interface 4, and a compensating device 5, which are connected with each other, wiredly via signal lines and power lines, or wirelessly. Note that the robot system 1 is constructed inside and outside a given workspace. For example, the robot 2 is disposed inside the workspace, and the control devices 3, the user interface 4, and the compensating device 5 are disposed outside the workspace.

The robot 2 is an articulated robotic arm having a plurality of joints, which is capable of moving a tip end of an arm to an arbitrary location within a given range by driving motors of respective parts. An adapter is provided at the tip end of the arm, to which various end effectors according to works can be attached. For example, if a suction gripper is attached as the end effector, it sucks and grips a component after being processed, carries the component via a suitable route to a location where the subsequent process will be performed, and places the component at a given location.

Moreover, the robot 2 is provided with various sensors needed for suitably performing a work. For example, in order to grasp an own posture, the robot 2 is provided with encoders which detect rotational angles of the motors at respective parts, infrared sensor(s) for grasping an obstacle which exists in the workspace, etc.

The control device 3 includes a processor (computer) 31 comprised of, for example, an MPU or a PLC, a memory 32 which is an internal memory having a ROM and/or a RAM, and an interface 33 which communicatably connects the control device 3 to the robot 2, the user interface 4, and the compensating device 5. The processor 31, the memory 32, and the interface 33 are mutually connected via a bus 34.

The memory 32 stores a computer program 32a according to the present disclosure. The processor 31 reads and executes the computer program 32a to serve as a computer according to the present disclosure to exhibit functions of an acquiring module which acquires a first condition, an acquiring module which acquires conversion information, and an acquiring module which acquires second corrected operation information. The details of these modules will be described later.

The user interface 4 is a device which accepts an operation instruction from the operator and inputs the operation instruction into the control device 3. The user interface 4 is provided with a mode selector (not illustrated), which enables the operator to select one of operating modes of the control device 3 from an automatic mode, a correction mode, and a learning mode. Among these, the automatic mode is a mode in which the robot 2 autonomously performs a given work according to a given program. The correction mode is a mode in which the operation of the robot 2 for the given work is corrected according to the input from the compensating device 5. The learning mode is, in short, a mode which performs processing to apply the operation logic of the robot 2 for a certain work to an operation of the robot 2 for another work. Note that the learning mode will be described in detail later.

Such a user interface 4 is configured to be operable by the operator, and may include, for example, a switch, an adjustment knob, a control lever, and/or a touch panel. Alternatively, the user interface 4 may be comprised of a tablet-type mobile terminal.

The compensating device 5 is a device operated by the operator when creating or correcting the operation of the robot 2 for a certain work, and the operated information is inputted into the control device 3. The compensating device 5 may be comprised of, for example, a teaching pendant, or similar to the user interface 4, may be comprised of a switch, an adjustment knob, a control lever, and/or a touch panel, or may be comprised of a tablet-type mobile terminal.

Note that the control device 3 may be switched into the correction mode, but not limited to, when the correction mode is selected by the mode selector of the user interface 4. For example, when the compensating device 5 is connected to the control device 3 from a disconnected state, the mode may be switched automatically to the correction mode.

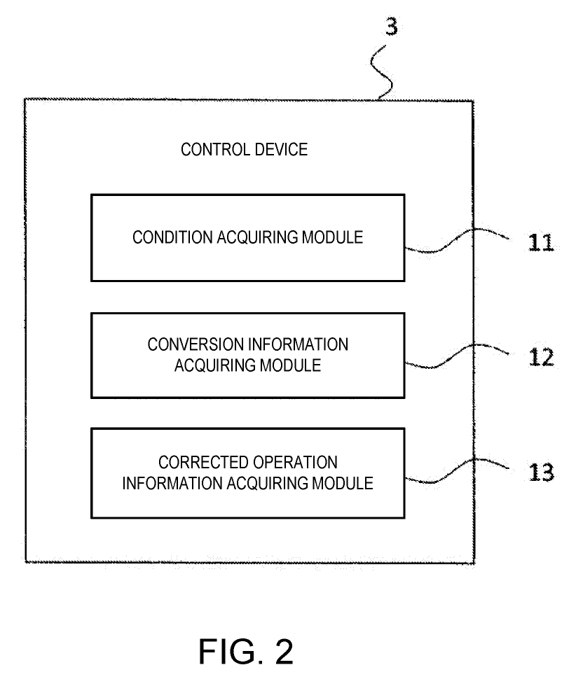

FIG. 2 is a block diagram illustrating a functional configuration of the control device 3. The control device 3 performs, in the learning mode, processing in which logic obtained from a correction in advance for the operation of the robot 2 for a certain work (model work) is applied to an operation of the robot 2 for another work (target work). Thus, the control device 3 causes the processor 31 to execute the computer program 32a to function as a condition acquiring module 11, a conversion information acquiring module 12, and a corrected operation information acquiring module 13.

The condition acquiring module 11 acquires a condition which defines a given model work (first condition), and a condition which defines a given target work (second condition), and stores the conditions in the memory 32. Among these, the “model work” is a work which is an acquiring source of the logic, and the “target work” is a work to which the logic is applied. Note that each condition may be acquired via the user interface 4 which the operator operates, or may be acquired by connecting an external memory, such as a USB (Universal Serial Bus), storing the conditions, to the interface 33 of the control device 3.

The conversion information acquiring module 12 acquires conversion information on the model work, and stores the information in the memory 32. Here, the “conversion information” is information for the model work, for acquiring first corrected operation information indicative of a corrected operation which is obtained by correcting a temporary operation from first temporary operation information indicative of a temporary operation of the robot 2 which satisfies the first condition. In other words, regarding the operation of the robot 2 for a given model work, logic which obtained the operation after correction (corrected operation) from the operation before the correction by the operator (temporary operation) is referred to as the conversion information.

The corrected operation information acquiring module 13 acquires information indicative of a corrected operation of the robot 2 for the target work (second corrected operation information) by using the first condition, the second condition, and the conversion information. Note that the corrected operation of the robot 2 for the target work corresponds to an operation of the robot 2 after the correction for the model work. That is, the corrected operation information acquiring module 13 acquires the corrected operation information corresponding to the corrected operation, without an actual correction by the operator. The acquired corrected operation information is stored in the memory 32.

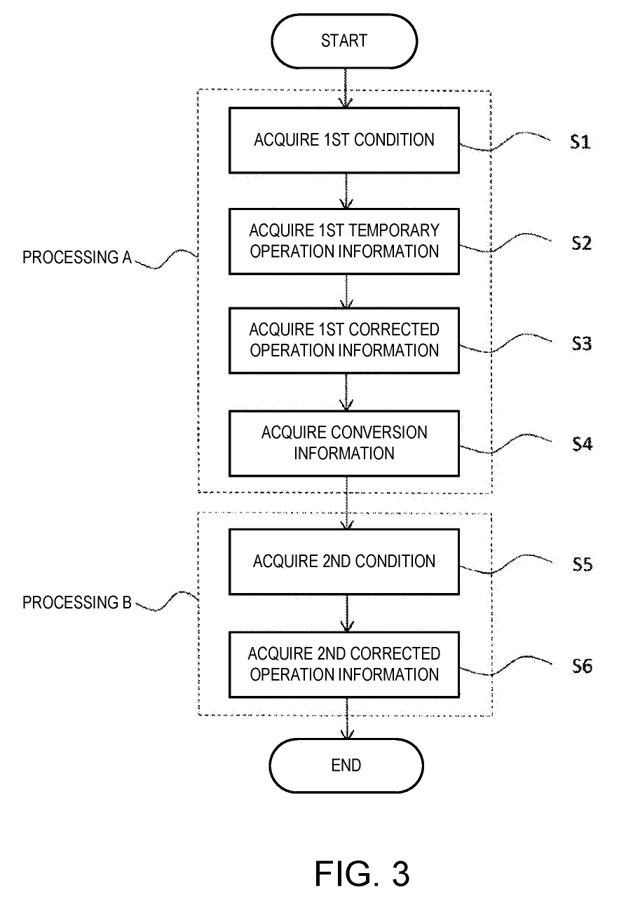

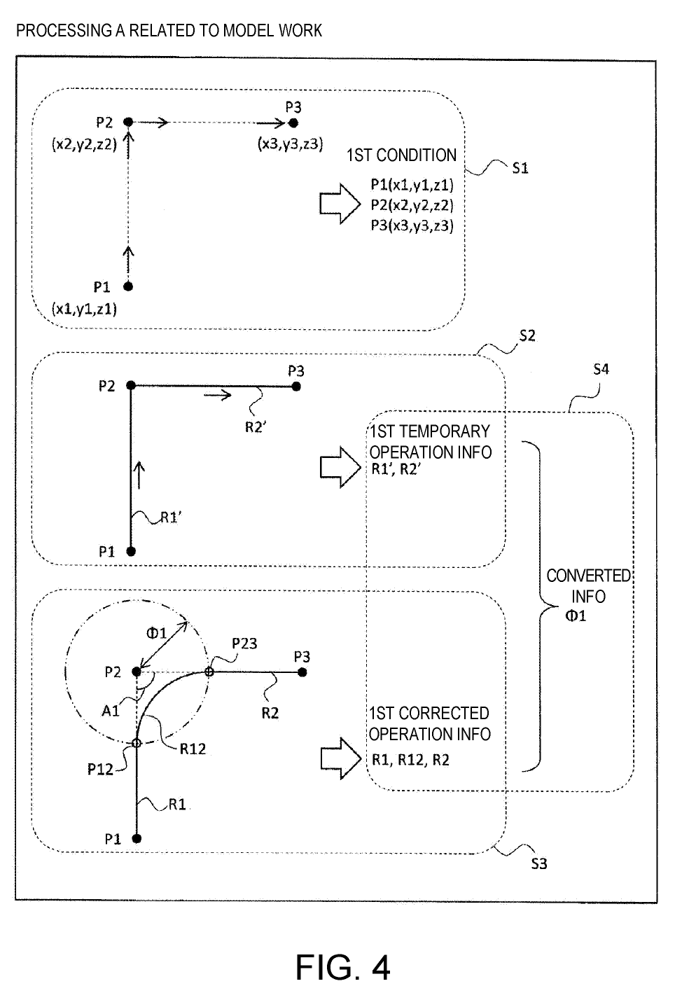

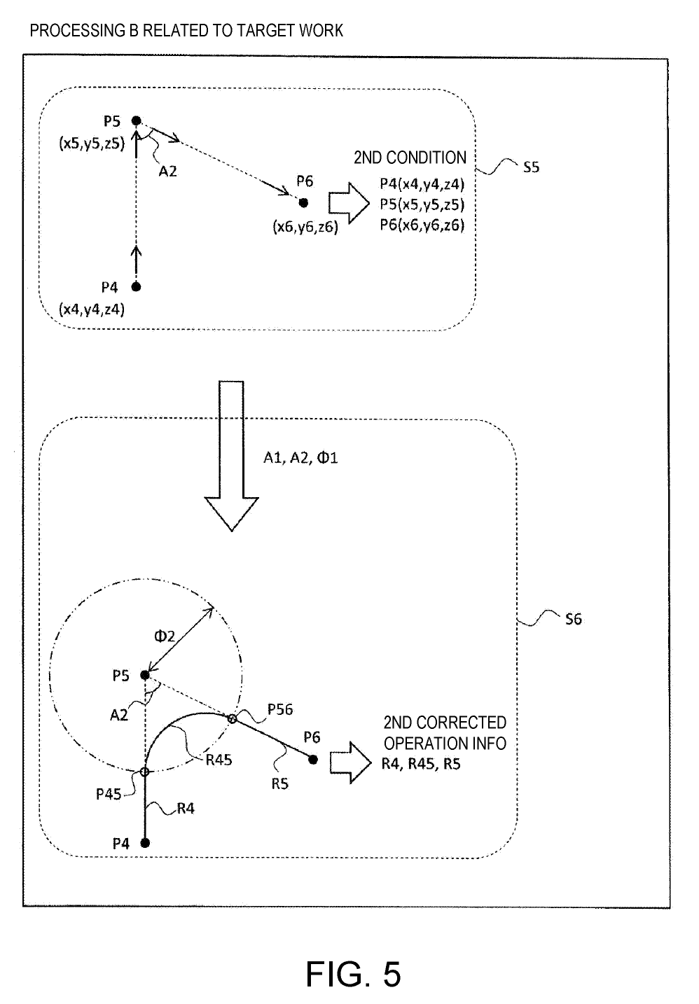

Next, the method of operating the robot by using such a robot system 1 is described. FIG. 3 is a flowchart illustrating the method of operating the robot 2. FIG. 4 is a view schematically illustrating one example of a control of the operation of the robot 2 according to a processing A of FIG. 3, and FIG. 5 is a view schematically illustrating one example of a control of the operation of the robot 2 according to a processing B of FIG. 3.

As illustrated in FIG. 3, the robot system 1 executes processing of Steps S1-S4 (processing A) for the given model work, then executes processing of Steps S5-S6 (processing B) for the given target work. In the processing A, the control device 3 mainly operates in the correction mode, and in the processing B, mainly operates in the learning mode. Here, as the model work, a work in which the robot 2 carries a workpiece from a point P1 to a point P3 via a point P2 is illustrated.

In the processing A, the robot system 1 first acquires the first condition which defines the model work (Step S1). For example, as three-dimensional or 3D coordinates of each of the points P1-P3 through which the location of the arm tip-end of the robot 2 passes when carrying the workpiece, P1(x1, y1, z1), P2(x2, y2, z2), and P3(x3, y3, z3) are inputted by the operator through the user interface 4, and the control device 3 acquires these coordinates (also see FIG. 4).

Here, the first condition of the model work is not limited to the 3D coordinates, but may be set suitably. For example, in addition to the 3D coordinates, an upper limit of a moving speed between the points may be set, or the weight of the workpiece to be carried may be set, or an upper limit of power consumption of the robot 2 may be set. Moreover, the first condition may include a workable area of the robot 2. Other than those described above, any conditions significant for defining the model work can suitably be set as the first condition. The first condition acquired at Step S1 is stored in the memory 32 of the control device 3.

Next, the robot system 1 acquires the first temporary operation information indicative of the temporary operation of the robot 2 which satisfies the first condition (Step S2). That is, since the operation of the robot 2 which executes the model work may not be one kind, the robot system 1 temporarily determines one operation example out of the model works, and uses this as the temporary operation. Then, the robot system 1 acquires the first temporary operation information which defines the temporary operation. The ways to define the temporary operation can be selected variously, and the operation along a route linearly connecting the points P1-P3 in this order is used as the temporary operation in this embodiment. That is, the robot system 1 acquires as the first temporary operation information, information on a route R1′ between points P1 and P2, information on a route R2′ between the points P2 and P3, as illustrated in FIG. 4. Such first temporary operation information may be automatically calculated by the given program based on the first condition, or may be inputted by the operator operating the user interface 4.

The robot system 1 acquires the first corrected operation information indicative of the corrected operation obtained by correcting the temporary operation (Step S3). That is, although the temporary operation is one of the operations of the robot 2 which can execute the model work, it may not be the optimal operation in terms of the work efficiency etc. Thus, based on the temporary operation, the operator corrects the temporary operation to create the corrected operation. The robot system 1 acquires the first corrected operation information indicative of the corrected operation created in this way by storing in the memory 32.

This embodiment (first embodiment) illustrates in FIG. 4 a case where, as one example of the correction of the temporary operation, the route when the robot 2 turns at the point P2 is corrected. For example, the turning route is corrected by changing a setting of accuracy. The term “accuracy” as used herein refers to a value of a radius φ centering on the turning point (point P2), and an area in a circle of this radius φ is considered to be the same as the turning point in a determination of whether a controlled target (the arm tip-end of the robot 2) reaches the turning point.

In the corrected operation illustrated in FIG. 4, the accuracy is set as a radius φ1. The circle of the accuracy intersects at a point P12 with a line segment connecting the points P1 and P2, and intersects at a point P23 with a line segment connecting the points P2 and P3. Here, the robot 2 which moves from the point P1 to the point P3 first moves linearly along a route R1 from the point P1 toward the point P2. Next, when the robot 2 reaches the point P12 on the circumference of the accuracy, the robot 2 is considered to be reached the point P2, and then starts a turn toward the point P3.

By the robot 2 moving along a arc-shaped route R12 from the point P12 to the point P23, it turns to conform to the route R2 at the point P23. That is, the route R12 has a tangent at the point P12 which is a starting point thereof is in agreement with the route R1, and a tangent at the point P23 which is a terminal point thereof is in agreement with the route R2. Thus, after the robot 2 departs from the point P1, it smoothly and continuously moves along the route R1 and then along the route R2 through the route R12, and then to the point P3. Note that, in the example of FIG. 4, the route R1 is located on the line segment connecting the points P1 and P2, and the route R2 is located on the line segment connecting the points P2 and P3.

Thus, from the corrected operation created in this way, the robot system 1 acquires the information on the route R1, the route R12, and the route R2 as the first corrected operation information indicative of the corrected operation (Step S3), and then stores the information in the memory 32.

Then, the robot system 1 acquires the conversion information for acquiring the first corrected operation information (R1, R12, R2) from the first temporary operation information (R1′, R2′) which has been previously acquired (Step S4). In this embodiment, the information on the turning route at the corrected point P2 is acquired as the conversion information. For example, the accuracy value φ1 is acquired as the conversion information, and the value is stored in the memory 32.

Next, the robot system 1 executes the processing of Steps S5-S6 (processing B) for the given target work, as illustrated in FIG. 3. Here, as the target work, a work which is the same kind as the model work, to carry the workpiece from a point P4 to a point P6 via a point P5 by the robot 2 is illustrated. Note that the layout of the points P1-P3 and the layout of the points P4-P6 differ between the model work and the target work. That is, a turning angle A1 at the waypoint P2 when simply connecting the points P1-P3 by straight lines for the model work is different from a turning angle A2 at the waypoint P5 when simply connecting the points P4-P6 by straight lines in the target work (see FIGS. 4 and 5).

The robot system 1 acquires the second condition which defines the target work (Step S5). Here, as the 3D coordinates of the points P4-P6 via which the location of the arm tip-end of the robot 2 passes when carrying the workpiece, P4(x4, y4, z4), P5(x5, y5, z5), and P6(x6, y6, z6) are inputted by the operator through the user interface 4, and the control device 3 acquires the coordinates (also see FIG. 5). Then, based on the first condition and the conversion information which are acquired for the model work, and the second condition, the robot system 1 acquires the second corrected operation information indicative of the corrected operation of the robot 2 for the target work (Step S6).

For example, based on the turning angle A1 at the waypoint P2 which is obtained from the first condition (the 3D coordinates of the points P1-P3), and the accuracy φ1 which is the conversion information, a general formula φ=f(A) representing a relation between the turning angle A and the accuracy φ is set beforehand, and stored in the memory 32. Processing to set the general formula may be executed, for example, after Step S4 in the processing A of FIG. 3. Next, the robot system 1 obtains an accuracy φ2 to be applied to the point P5 of the target work, from the turning angle A2 at the waypoint P5 obtained from the second condition (the 3D coordinates of the points P4-P6) for the target work, and the general formula. Then, the routes R4, R45, and R5 (see FIG. 5) which are operation routes of the robot 2 for the target work are acquired from the accuracy φ2 as the second corrected operation information.

As a result, when the robot 2 which operates according to the second corrected operation information departs from the point P4, it moves toward the point P5 along the linear route R4, and starts turning at the point P45 before reaching the point P5, and then moves along the arc-shaped route R45. Then, the robot 2 moves along the linear route R5 from the point P56, and reaches the point P6. During this period, the arm tip-end of the robot 2 moves smoothly and continuously.

By the robot system 1 according to this embodiment (first embodiment) described above, the operation information (second corrected operation information) for the target work, which corresponds to the first corrected operation information for the model work can easily be acquired. That is, the second corrected operation information on the target work can easily be acquired by applying the logic when the first corrected operation information on the model work is acquired, without teaching of the operator etc. The first embodiment is described above.

Next, a second embodiment which is obtained by modifying the first embodiment is described. The second embodiment differs from the first embodiment in that a plurality of first corrected operation information and a plurality of conversion information are acquired from the first temporary operation information (R1′, R2′). Then, the second corrected operation information is acquired using the first condition, the second condition, and the plurality of conversion information. Other configurations in the second embodiment are similar to those of the first embodiment.

The details of the difference of the second embodiment from the first embodiment, i.e., acquiring the plurality of first corrected operation information and the plurality of conversion information from the first temporary operation information (R1′, R2′), and acquiring the second corrected operation information using the first condition, the second condition, and the plurality of the conversion information, are as follows.

Here, a case where two conversion information are acquired is described. Moreover, there are two operators who operate the compensating device 5 etc. Let the two operators be an operator a and an operator b.

When the first temporary operation information (R1′, R2′) is given based on the first condition (P1, P2, P3), the operator first corrects the operation (operation of the robot based on the first temporary operation information) to create the first corrected operation information a. Thus, when the first corrected operation information a is acquired, the conversion information a which is information (logic) for acquiring the first corrected operation information a from first temporary operation information (R1′, R2′) can be acquired. Here, suppose that a radius φ1a of the accuracy is obtained as conversion information a.

Next, the operator b then corrects the first temporary operation information (R1′, R2′) which is given based on the first condition (P1, P2, P3). That is, the operator b corrects the operation of the robot based on the first temporary operation information to create the first corrected operation information b. Thus, when the first corrected operation information b is acquired, the conversion information b which is information (logic) for acquiring the first corrected operation information b from the first temporary operation information (R1′, R2′) can be acquired. Here, suppose that a radius φ1b of the accuracy is obtained as conversion information b.

Next, a radius φ1m which is an average value of the radius φ1a and the radius φ1b is calculated. For example, it is calculated by a formula of “φ1m=(φ1a+φ1b)/2.” Then, a general formula φ=f(A) which represents a relation between the turning angle A1 at the waypoint P2 obtained from the first condition (the 3D coordinates of the points P1-P3) and the radius φ1m is set, and is stored in the memory 32. Thus, the second embodiment differs from the first embodiment in that the plurality of first corrected operation information is acquired, the plurality of conversion information is acquired, and the general formula φ=f(A) is set.

Thereafter, the second embodiment is the same as the first embodiment in that the accuracy φ2 to be applied to the point P5 for the target work is obtained from the turning angle A2 at the waypoint P5 obtained from the second condition (the 3D coordinates of the points P4-P6) and the general formula φ=f(A), and the routes R4, R45, and R5 (see FIG. 5) which are operation routes of the robot 2 for the target work are acquired from the accuracy φ2 as the second corrected operation information.

In the second embodiment, since the second corrected operation information is created using the plurality of conversion information, it can be expected that more appropriate second corrected operation information is acquired while eliminating the operator's individuality. The second embodiment is described above.

Note that although in the above description (description of the first and second embodiments) the 3D coordinates of the location points are illustrated as the first condition and the second condition, processed information based on the coordinates may be used as the first condition and the second condition. For example, the turning angle A1 of the model work may be adopted as the first condition, and the turning angle A2 of the target work may be adopted as the second condition. Alternatively, a difference of the turning angles (=A2-A1) may collectively be adopted as the first condition and the second condition. Thus, the “processing in which the second corrected operation information is acquired using the first condition, the second condition, and the conversion information” at Step S6 includes, without limited to the case where the first condition, the second condition, and the conversion information are used as they are, a form where the second corrected operation information is acquired using other information acquirable from some or all of the first condition, the second condition, and the conversion information.

Moreover, although in the above description only the case where the information on the correction of the turning route is acquired as the conversion information is illustrated, the conversion information may be acquired by setting the model work beforehand for the various operations of the robot 2. Therefore, when the target work is a series of works including a plurality of processes, the corrected operation information of the robot 2 can be acquired for the entire target work by executing the processing of Steps S5-S6 for each process.

### DESCRIPTION OF REFERENCE CHARACTERS

1 Robot System
2 Robot
3 Control Device
4 User Interface
5 Compensating Device
11 Condition Acquiring Module
12 Conversion Information Acquiring Module
13 Corrected Operation Information Acquiring Module
31 Processor
32 Memory
32a Computer Program

1. A method of operating a robot configured to perform a series of works including a plurality of processes, comprising:
acquiring a first condition that defines a given model work;
acquiring for the model work, conversion information for acquiring first corrected operation information indicative of corrected operation obtained by correcting a temporary operation based on first temporary operation information indicative of the temporary operation of the robot that satisfies the first condition;
acquiring a second condition that defines a given target work; and
acquiring second corrected operation information indicative of corrected operation of the robot for the target work based on the first condition, the second condition, and the conversion information.

2. The method of claim 1, wherein the conversion information is comprised of a plurality of conversion information, and the first corrected operation information is comprised of a plurality of first corrected operation information corresponding to the plurality of conversion information, respectively.

3. A non-transitory computer-readable recording medium storing a computer program causing a computer of a robot system to execute processing, the robot system further comprising a robot configured to execute a series of works including a plurality of processes, the computer configured to control operation of the robot, the processing comprising:
acquiring a first condition that defines a given model work;
acquiring for the model work, conversion information for acquiring first corrected operation information indicative of corrected operation obtained by correcting a temporary operation based on first temporary operation information indicative of the temporary operation of the robot that satisfies the first condition;
acquiring a second condition that defines a given target work; and
acquiring second corrected operation information indicative of corrected operation of the robot for the target work based on the first condition, the second condition, and the conversion information.

4. The recording medium of the claim 3, wherein the conversion information is comprised of a plurality of conversion information, and the first corrected operation information is comprised of a plurality of first corrected operation information corresponding to the plurality of conversion information, respectively.

5. A robot system configured to perform a series of works including a plurality of processes, comprising:
a robot;
a memory storing a first condition that defines a given model work, and for the model work, conversion information for acquiring first corrected operation information indicative of corrected operation obtained by correcting a temporary operation based on first temporary operation information indicative of the temporary operation of the robot that satisfies the first condition; and
a processor configured to acquire second corrected operation information indicative of corrected operation of the robot for the target work based on the first condition, the conversion information, and a second condition that defines a given target work.

6. The robot system of claim 5, wherein the conversion information is comprised of a plurality of conversion information, and the first corrected operation information is comprised of a plurality of first corrected operation information corresponding to the plurality of conversion information, respectively.
